(19) United States
(12) Patent Application Publication
(10) Pub. No.: US 2009/0221749 A1
(43) Pub. Date: Sep. 3, 2009

(54) POLYMER HAVING NAPHTHYL GROUP AND PRODUCING METHOD THEREOF

(75) Inventors: Takahisa Konishi, Shimohozumi (JP); Yutaka Ohmori, Shimohozumi (JP); Hisae Sugihara, Shimohozumi (JP); Miyuki Kurogi, Shimohozumi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/091,991

(22) PCT Filed: Oct. 17, 2006
(86) PCT No.: PCT/JP2006/320629

§ 371 Date: Jan. 14, 2009

(30) Foreign Application Priority Data
Nov. 21, 2005 (JP) 2005-335165

(51) Int. Cl. C08F 8/00

(52) U.S. Cl. 525/61

(57) ABSTRACT

The object of the present invention is to provide a polymer excellent in transparency and heat resistance.

A polymer having at least a repeating unit represented by the following general formula (I):

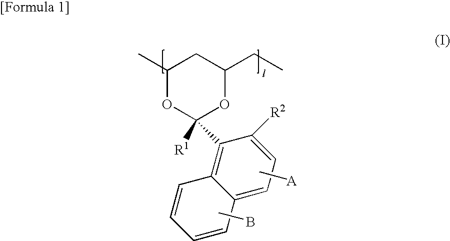

wherein in the general formula (I), R¹ denotes a hydrogen atom, a straight-chain or branched alkyl group with a carbon number of 1 to 4, or a substituted or unsubstituted phenyl group; R², A and B each independently denote a hydrogen atom, a halogen atom, a straight-chain or branched alkyl group with a carbon number of 1 to 4, a straight-chain or branched alkyl halide group with a carbon number of 1 to 4, a straight-chain or branched alkoxy group with a carbon number of 1 to 4, an alkoxycarbonyl group, an acyloxy group, an amino group, an azide group, a nitro group, a cyano group or a hydroxyl group (however, R² is not a hydrogen atom); and l denotes an integer of 2 or more.

### TECHNICAL FIELD

The present invention relates to a new polymer having a naphthyl group and a producing method thereof.

### BACKGROUND ART

Transparent polymeric materials have been used for various applications in electrical, electronic and optical fields. Conventionally, polymethyl methacrylate resin and polycarbonate resin have been known as optical polymeric materials. Polymethyl methacrylate resin is a material greatly excellent in transparence but has high hygroscopicity and has a problem in heat resistance and physical strength. On the other hand, polycarbonate resin is excellent in low water absorption properties, heat resistance and shock resistance but has a defect such as to easily cause optical strain. Polyvinyl acetal resin has widely been used as an interlayer of window glass for such as automobiles and buildings (see patent document 1). Also, it is disclosed that polyvinyl acetal resin has been used as a substrate for optical discs (see patent document 2). However, conventional polyvinyl acetal resin has a problem in transparence and heat resistance by reason of causing white turbidness under an environment of high temperature and high humidity, and being deformed under an environment of high temperature. Thus, the solution of the problems has been desired.

[Patent Document 1] Japanese Unexamined Patent Publication No. 8-026785

[Patent Document 2] Japanese Unexamined Patent Publication No. 62-036448

### DISCLOSURE OF THE INVENTION

The present invention has been made to solve such problems, and the object thereof is to provide a polymer excellent in transparency and heat resistance.

Through earnest studies for solving the above-mentioned problems, the inventors of the present invention have completed the present invention by finding out that a polymer described below allows the above-mentioned object to be achieved.

A polymer of the present invention has at least a repeating unit represented by the following general formula (I).

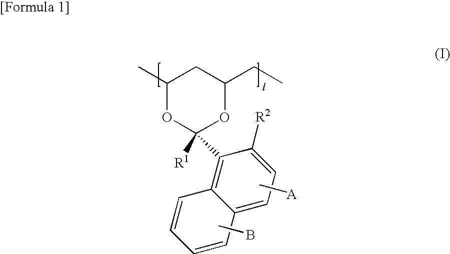

In the general formula (I), R¹ denotes a hydrogen atom, a straight-chain or branched alkyl group with a carbon number of 1 to 4, or a substituted or unsubstituted phenyl group; R², A and B each independently denote a hydrogen atom, a halogen atom, a straight-chain or branched alkyl group with a carbon number of 1 to 4, a straight-chain or branched alkyl halide group with a carbon number of 1 to 4, a straight-chain or branched alkoxy group with a carbon number of 1 to 4, an alkoxycarbonyl group, an acyloxy group, an amino group, an azide group, a nitro group, a cyano group or a hydroxyl group (however, R² is not a hydrogen atom); and l denotes an integer of 2 or more.

In a preferable embodiment, the above-mentioned R¹ is a hydrogen atom.

In a preferable embodiment, the R² is a methoxy group.

In a preferable embodiment, the polymer further has a repeating unit represented by the following general formula (II).

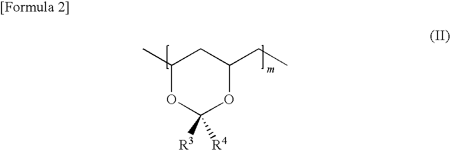

In the general formula (II), R³ and R⁴ each independently denote a hydrogen atom, a straight-chain or branched alkyl group with a carbon number of 1 to 4, a substituted or unsubstituted cycloalkyl group with a carbon number of 5 to 10, a substituted or unsubstituted phenyl group, a substituted or unsubstituted naphthyl group, or a substituted or unsubstituted heterocyclic group; and m denotes an integer of 2 or more.

In a preferable embodiment, the R³ is a hydrogen atom.

In a preferable embodiment, the R⁴ is a straight-chain or branched alkyl group with a carbon number of 1 to 4, or a substituted or unsubstituted phenyl group.

In a preferable embodiment, the polymer further has a repeating unit represented by the following general formula (III).

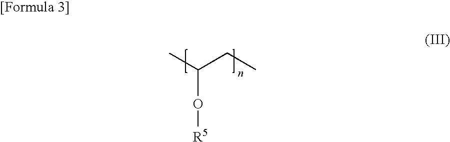

In the general formula (III), R⁵ denotes a hydrogen atom, a straight-chain or branched alkyl group with a carbon number of 1 to 4, a benzyl group, a silyl group, a phosphate group, an acyl group, a benzoyl group, or a sulfonyl group; and n denotes an integer of 2 or more.

In a preferable embodiment, glass transition temperature of the polymer is 90 to 190° C.

According to another aspect of the present invention, an optical member is provided. This optical member contains the above-mentioned polymer.

According to another aspect of the present invention, A producing method for the polymer is provided. The producing method comprises at least a step of reacting a compound represented by the following general formula (IX) with polyvinyl alcohol resin in the presence of an acid catalyst while dissolved or dispersed in solvent.

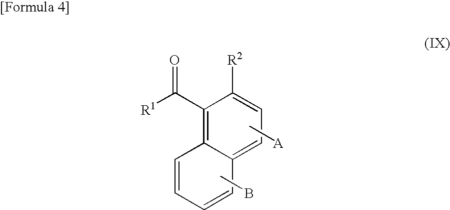

In the general formula (IX), R¹ denotes a hydrogen atom, a straight-chain or branched alkyl group with a carbon number of 1 to 4, or a substituted or unsubstituted phenyl group; and R², A and B each independently denote a hydrogen atom, a halogen atom, a straight-chain or branched alkyl group with a carbon number of 1 to 4, a straight-chain or branched alkyl halide group with a carbon number of 1 to 4, a straight-chain or branched alkoxy group with a carbon number of 1 to 4, an alkoxycarbonyl group, an acyloxy group, an amino group, an azide group, a nitro group, a cyano group or a hydroxyl group (however, R² is not a hydrogen atom).

In a preferable embodiment, saponification degree of the polyvinyl alcohol resin is 80 mol % or more.

In a preferable embodiment, average degree of polymerization of the polyvinyl alcohol resin is 400 to 5000.

In a preferable embodiment, comprising a step of drying the polyvinyl alcohol resin before the reaction.

In a preferable embodiment, the solvent is N,N-dimethylformaldehyde, N-methylpyrrolidone or dimethyl sulfoxide.

In a preferable embodiment, the acid catalyst is hydrochloric acid, sulfuric acid, phosphoric acid or para-toluenesulfonic acid.

A polymer of the present invention is excellent in transparency and heat resistance by reason of having a naphthyl group in a molecular structure. In addition, a molded product containing the above-mentioned polymer exhibits properties (inverse wavelength dispersion properties) in the case of having birefringence, such that higher birefringence is offered in measuring by light with longer wavelength, by adjusting composition ratio of the above-mentioned polymer in a specific range. Such a molded product is extremely useful for optical applications.

### BRIEF DESCRIPTION OF THE DRAWINGS

FIG. 1 is a graph showing wavelength dependence of birefringence in a visible light region with regard to a drawn film of examples.

### BEST MODE FOR CARRYING OUT THE INVENTION

### 1. A Polymer of the Present Invention

A polymer of the present invention has at least a repeating unit represented by following general formula (I). The above-mentioned polymer is excellent in transparency and heat resistance by reason of having a naphthyl group in a molecular structure.

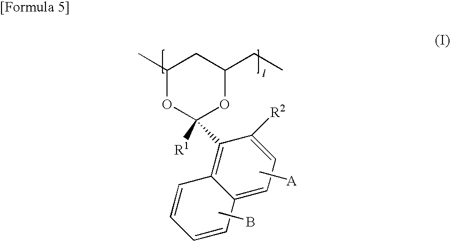

The above-mentioned polymer can be obtained, for example, by subjecting at least two kinds of aldehyde compounds and/or ketone compounds, and polyvinyl alcohol resin to condensation reaction. In the present specification, the above-mentioned polymer includes a polymer (the so-called high polymer) such that a repeating unit; l (polymerization degree) is 20 or more and weight-average molecular weight is high. In addition, the above-mentioned polymer includes a low polymer (the so-called oligomer) such that a repeating unit; l (polymerization degree) is 2 or more and less than 20 and weight-average molecular weight is approximately several thousands.

In the general formula (I), R¹ denotes a hydrogen atom, a straight-chain or branched alkyl group with a carbon number of 1 to 4, or a substituted or unsubstituted phenyl group. In condensation reaction of polyvinyl alcohol resin, a hydrogen atom is introduced into R¹ in the case of using aldehyde compounds. In the condensation reaction of polyvinyl alcohol resin, a substituent except a hydrogen atom is introduced into R¹ in the case of using ketone compounds. R¹ is preferably hydrogen atoms.

R², A and B each independently denote a hydrogen atom, a halogen atom, a straight-chain or branched alkyl group with a carbon number of 1 to 4, a straight-chain or branched alkyl halide group with a carbon number of 1 to 4, a straight-chain or branched alkoxy group with a carbon number of 1 to 4, an alkoxycarbonyl group, an acyloxy group, an amino group, an azide group, a nitro group, a cyano group or a hydroxyl group (however, R² is not a hydrogen atom). R² is a substituent substituted in 2-position of a naphthyl ring, and A is a substituent substituted in 3-position or 4-position of a naphthyl ring. B is a substituent substituted in 5-position to 8-position of a naphthyl ring. R² is preferably a methoxy group. A and B are preferably hydrogen atoms.

R² is used for controlling steric conformation of a naphthyl ring to which the substituent is bonded. More specifically, it is assumed that the substituent easily conforms by steric hindrance between two oxygen atoms in the general formula (I). Then, the planar structure of the naphthyl ring is oriented substantially orthogonally to an imaginary line connecting the two oxygen atoms. Such a polymer is excellent in transparency and heat resistance.

The base unit; l represented by the general formula (I) can be obtained, for example, by condensation reaction with polyvinyl alcohol resin and 1-naphthaldehydes or 1-naphthones. The 1-naphthaldehydes can be adopted properly and appropriately. Examples of the 1-naphthaldehydes include 2-methoxy-1-naphthaldehyde, 2-ethoxy-1-naphthaldehyde, 2-propoxy-1-naphthaldehyde, 2-methyl-1-naphthaldehyde and 2-hydroxy-1-naphthaldehyde. The 1-naphthones can be adopted properly and appropriately. Examples of the 1-naphthones include 2-hydroxy-1-acetonaphthone and 8′-hydroxy-1′-benzonaphthone. Among these, 2-methoxy-1-naphthaldehyde is preferable (in this case in the general formula (I), R² is a methoxy group, and A and B are hydrogen atoms).

The above-mentioned 1-naphthaldehydes can be obtained by an optional appropriate synthesis method. Examples of a synthesis method of the 1-naphthaldehydes include a method of reacting substituted or unsubstituted naphthoic acid with optional alcohol to obtain substituted or unsubstituted naphthoate, which is thereafter reduced with reducing agents such as diisobutylaluminum hydride and hydrogenated bis(2-methoxyethoxy)aluminum sodium. Commercially available articles can also be used directly for the 1-naphthaldehydes. Commercial 1-naphthaldehydes are available from AIR WATER CHEMICAL INC. and Daiwa Kasei K. K., for example.

The above-mentioned 1-naphthones can be obtained by an optional appropriate synthesis method. Examples of a synthesis method of the 1-naphthones include a method of reacting substituted or unsubstituted naphthoic acid with appropriate phosphoric halide and thionyl chloride to obtain an acyl halide, which is thereafter further reacted with an appropriate nucleophilic reagent. As other methods of the synthesis method of the 1-naphthones, a method described in Reference Example 1 of Japanese Patent No. 2846418 can also be used.

In one embodiment, the above-mentioned polymer has at least a repeating unit represented by the above-mentioned general formula (I) as well as a repeating unit represented by the following general formula (II). In the above-mentioned polymer, the sequence of the repeating units l and m is not particularly limited but may be any of alternating, random and block. The above-mentioned polymer can be obtained, for example, by subjecting at least two kinds of aldehyde compounds and/or ketone compounds, and polyvinyl alcohol resin to condensation reaction.

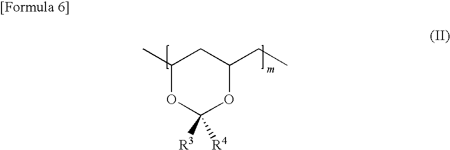

In the general formula (II), R³ and R⁴ each independently denote a hydrogen atom, a straight-chain or branched alkyl group with a carbon number of 1 to 4, a substituted or unsubstituted cycloalkyl group with a carbon number of 5 to 10, a substituted or unsubstituted phenyl group, a substituted or unsubstituted naphthyl group, or a substituted or unsubstituted heterocyclic group; and m denotes an integer of 2 or more. A polymer such that such a substituent is introduced into R³ and R⁴ is excellent in solubility in all-purpose solvent (such as acetone, ethyl acetate and toluene). The above-mentioned R³ is preferably a hydrogen atom. The above-mentioned R⁴ is preferably a straight-chain or branched alkyl group with a carbon number of 1 to 4, or a substituted or unsubstituted phenyl group. A polymer having such a substituent is further excellent in transparency, heat resistance and molding processability.

In the above-mentioned polymer, the repeating unit; m represented by the general formula (II) can be obtained, for example, by condensation reaction of polyvinyl alcohol resin and optional aldehyde compounds or ketone compounds. Examples of the aldehyde compounds include formaldehyde, acetaldehyde, 1,1-diethoxyethane (acetal), propionaldehyde, n-butyraldehyde, isobutyraldehyde, cyclohexane carboxyaldehyde, 5-norbornene-2-carboxyaldehyde, 3-cyclohexene-1-carboxyaldehyde, dimethyl-3-cyclohexene-1-carboxyaldehyde, benzaldehyde, 2-chlorobenzaldehyde, para-dimethylaminobenzaldehyde, tert-butylbenzaldehyde, 3,4-dimethoxybenzaldehyde, 2-nitrobenzaldehyde, 4-cyanobenzaldehyde, 4-carboxybenzaldehyde, 4-phenylbenzaldehyde, 4-fluorobenzaldehyde, 2-(trifluoromethyl)benzaldehyde, 1-naphthaldehyde, 2-naphthaldehyde, 6-methoxy-2-naphthaldehyde, 3-methyl-2-thiophenecarboxyaldehyde, 2-pyridinecarboxyaldehyde and indole-3-carboxyaldehyde.

Examples of the ketone compounds include acetone, ethyl methyl ketone, diethyl ketone, tert-butyl ketone, dipropyl ketone, allyl ethyl ketone, acetophenone, para-methylacetophenone, 4′-aminoacetophenone, para-chloroacetophenone, 4′-methoxyacetophenone, 2′-hydroxyacetophenone, 3′-nitroacetophenone, P-(1-piperidino)acetophenone, benzalacetophenone, propiophenone, benzophenone, 4-nitrobenzophenone, 2-methylbenzophenone, para-bromobenzophenone, cyclohexyl(phenyl)methanone, 2-butyronaphthone and 1-acetonaphthone.

In the above-mentioned polymer, ratios of the repeating units l and m represented by each of the general formulae (I) and (II) can properly be set at appropriate values depending on the purpose. The ratio of the above-mentioned repeating unit; l is preferably 5 to 40 mol %, more preferably 5 to 30 mol % and particularly preferably 10 to 20 mol %. The ratio of the above-mentioned repeating unit; m is preferably 20 to 80 mol %, more preferably 40 to 75 mol % and particularly preferably 50 to 75 mol %. A polymer further excellent in transparency and heat resistance can be obtained by setting ratios of the repeating units l and m in the above-mentioned ranges.

The ratio; l/m (mol/mol) of the above-mentioned repeating units l and m is preferably 0.10 to 0.50, more preferably 0.12 to 0.40 and particularly preferably 0.15 to 0.40. The setting of the ratios of the repeating units; l and m in the above-mentioned ranges allows a molded product using the above-mentioned polymer to exhibit properties (the so-called inverse wavelength dispersion properties) in the case of having birefringence, such that higher birefringence is offered in measuring by light with longer wavelength. A polymer exhibiting such properties is appropriate for optical members such as birefringent film and plastic lens.

In one embodiment, a polymer of the present invention has at least a repeating unit represented by the above-mentioned general formula (I) as well as a repeating unit represented by the following general formula (III). For example, the above-mentioned polymer has at least a repeating unit represented by the above-mentioned general formula (I), a repeating unit represented by the above-mentioned general formula (II) and a repeating unit represented by the following general formula (III). In the above-mentioned polymer, the sequence of each of the repeating units is not particularly limited but may be any of alternating, random and block.

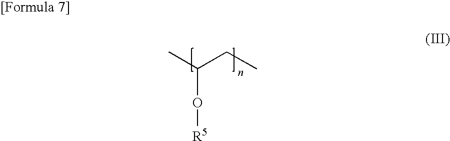

In the general formula (III), R⁵ denotes a hydrogen atom, a straight-chain or branched alkyl group with a carbon number of 1 to 4, a benzyl group, a silyl group, a phosphate group, an acyl group, a benzoyl group, or a sulfonyl group.

The above-mentioned R⁵ is used for adjusting coefficient of water absorption to an appropriate value by protecting a remaining hydroxyl group (also referred to as end cap treatment). For example, with regard to a molded product using the above-mentioned polymer, lower coefficient of water absorption allows a molded product having high transparency. The substituent may not be subject to end cap treatment (that is, R⁵ may be a hydrogen atom), depending on use and purpose for the polymer of the present invention. Examples of R⁵ to be used include an optional appropriate group (typically, a protecting group) capable of forming a substituent by reacting with a hydroxyl group after obtaining a polymer with the hydroxyl group remaining (that is, capable of end cap treatment).

Examples of the above-mentioned protecting group include benzyl group, 4-methoxyphenylmethyl group, methoxymethyl group, trimethylsilyl group, triethylsilyl group, tert-butyldimethylsilyl group, acetyl group, benzoyl group, methanesulfonyl group and bis-4-nitrophenyl phosphite. R⁵ is preferably trimethylsilyl group, triethylsilyl group or tert-butyldimethylsilyl group. A polymer having these substituents allows a molded product having high transparency even under an environment of high temperature and high humidity.

The reaction conditions of the above-mentioned end cap treatment can adopt proper and appropriate conditions in accordance with kinds of substituents reacted with the hydroxyl group. Reactions such as alkylation, benzylation, sililation, phosphorylation and sulfonylation can be performed by stirring a polymer with the hydroxyl group remaining and a chloride of an intended substituent in the presence of a catalyst such as 4(N,N-dimethylamino)pyridine at a temperature of 25 to 100° C. for 1 to 20 hours.

In the above-mentioned polymer, ratio of a repeating unit; n represented by the above-mentioned general formula (III) can properly be set at an appropriate value depending on the purpose. The ratio of the above-mentioned repeating unit; n is preferably 1 to 60 mol %, more preferably 5 to 50 mol %, particularly preferably 10 to 40 mol % and most preferably 10 to 25 mol %. The setting of the ratio of the repeating unit; n in the above-mentioned range allows a molded product excellent in transparency even under an environment of high temperature and high humidity.

In one embodiment, a polymer of the present invention has at least a repeating unit represented by the following general formula (IV). In the general formula (IV), a base unit; o can be obtained, for example, by introducing a substituted or unsubstituted benzaldehyde into a polymer. The use of such a polymer allows a molded product further excellent in transparency and heat resistance.

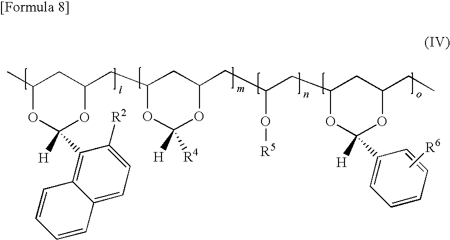

In the general formula (IV), R², R⁴ and R⁵ are the same as described in the above (the general formula (I), (II) and (III)). R⁶ denotes a hydrogen atom, a halogen atom, a straight-chain or branched alkyl group with a carbon number of 1 to 4, a straight-chain or branched alkyl halide group with a carbon number of 1 to 4, a straight-chain or branched alkoxy group with a carbon number of 1 to 4, an alkoxycarbonyl group, an acyloxy group, an amino group, a nitro group, a cyano group or a hydroxyl group. R⁶ is a substituent substituted in ortho-position, meta-position or para-position of a benzene ring.

In the general formula (IV), ratios of the base units; l, m, n and o can be selected at appropriate values depending on the purpose. The ratio of the base unit; l is preferably 1 to 20 mol %, more preferably 5 to 15 mol %. The ratio of the base unit; m is preferably 25 to 50 mol %, more preferably 30 to 50 mol %. The ratio of the base unit; n is preferably 10 to 55 mol %, more preferably 15 to 50 mol %. The ratio of the base unit; o is preferably 1 to 20 mol %, more preferably 5 to 15 mol %.

In addition, the ratio [l/(m+o)] (mol/mol) of the base unit l to the total of the base units m and o is preferably 0.10 to 0.50, more preferably 0.12 to 0.40 and particularly preferably 0.15 to 0.30. The setting of the ratios of the base units; l, m, n and o in the above-mentioned ranges allows the polymer to exhibit excellent properties such as to have transparency, heat resistance and inverse wavelength dispersion properties (in the case of having birefringence) together.

In another embodiment, a polymer of the present invention has at least a repeating unit represented by the following general formula (V). In the general formula (V), the base unit; p can be obtained, for example, by introducing an ethylene-vinylalcohol copolymer into a polymer. The use of such a polymer allows a molded product further excellent in transparency and heat resistance. In the formula (V), R², R⁴ and R⁵ are the same as described in the above.

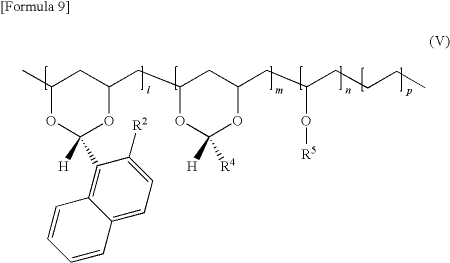

In the general formula (V), ratios of the base units; l, m, n and p can be selected at appropriate values depending on the purpose. The ratio of the base unit; l is preferably 5 to 25 mol %, more preferably 8 to 20 mol %. The ratio of the base unit; m is preferably 35 to 60 mol %, more preferably 40 to 55 mol %. The ratio of the base unit; n is preferably 10 to 40 mol %, more preferably 15 to 35 mol %. The ratio of the base unit; p is preferably 2 to 25 mol %, more preferably 5 to 20 mol %.

In addition, the ratio [l/(m+p)] (mol/mol) of the base unit l to the total of the base units m and p is preferably 0.08 to 0.40, more preferably 0.10 to 0.35 and particularly preferably 0.12 to 0.30. The setting of the ratios of the base units; l, m, n and p in the above-mentioned ranges allows a molded product using the above-mentioned polymer to exhibit excellent properties such as to have transparency, heat resistance and inverse wavelength dispersion properties (in the case of having birefringence) together.

In a further embodiment, a polymer of the present invention has at least a repeating unit represented by the following general formula (VI). In the general formula (VI), the base unit; q can be obtained, for example, by introducing a substituted or unsubstituted 2-naphthaldehyde into a polymer. The use of such a polymer allows a molded product further excellent in transparency and heat resistance.

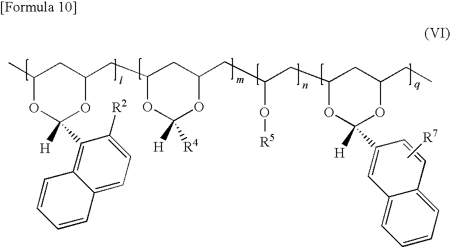

In the general formula (VI), R², R⁴ and R⁵ are the same as described in the above. R⁷ denotes a hydrogen atom, a halogen atom, a straight-chain or branched alkyl group with a carbon number of 1 to 4, a straight-chain or branched alkyl halide group with a carbon number of 1 to 4, a straight-chain or branched alkoxy group with a carbon number of 1 to 4, an alkoxycarbonyl group, an acyloxy group, an amino group, a nitro group, a cyano group or a hydroxyl group. R⁷ is a substituent substituted in any of 1-position or 3-position to 8-position. A naphthyl group substituted in the base unit; q is preferably a hydrogen atom in 1-position and 3-position thereof.

In the general formula (VI), ratios of the base units; l, m, n and q can be selected at appropriate values depending on the purpose. The ratio of the base unit; l is preferably 1 to 20 mol %, more preferably 5 to 15 mol %. The ratio of the base unit; m is preferably 20 to 55 mol %, more preferably 20 to 50 mol %. The ratio of the base unit; n is preferably 10 to 65 mol %, more preferably 15 to 60 mol %. The ratio of the base unit; q is preferably 1 to 15 mol %, more preferably 5 to 10 mol %.

In addition, the ratio [l/(m+q)] (mol/mol) of the base unit l to the total of the base units m and q is preferably 0.10 to 0.50, more preferably 0.12 to 0.40 and particularly preferably 0.15 to 0.30. The setting of the ratios of the base units; l, m, n and q in the above-mentioned ranges allows a molded product using the above-mentioned polymer to exhibit excellent properties such as to have transparency, heat resistance, and inverse wavelength dispersion properties (in the case of having birefringence) together.

In a further embodiment, a polymer of the present invention contains a polymer having at least a repeating unit represented by the following general formula (VII). In the general formula (VII), the base unit; r can be obtained, for example, by introducing substituted or unsubstituted cyclohexane carboxyaldehyde into a polymer. The use of such a polymer allows a molded product further excellent in transparency and heat resistance.

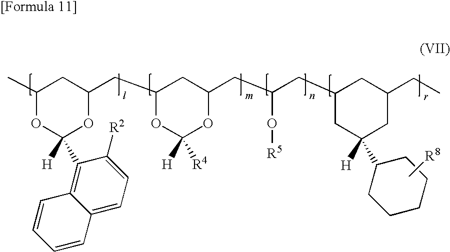

In the general formula (VII), R², R⁴ and R⁵ are the same as described in the above. R⁸ denotes a hydrogen atom, a halogen atom, a straight-chain or branched alkyl group with a carbon number of 1 to 4, a straight-chain or branched alkyl halide group with a carbon number of 1 to 4, a straight-chain or branched alkoxy group with a carbon number of 1 to 4, an alkoxycarbonyl group, an acyloxy group, an amino group, a nitro group, a cyano group or a hydroxyl group. R⁸ is a substituent substituted in any of 2-position to 6-position.

In the general formula (VII), ratios of the base units; l, m, n and r can be selected at appropriate values depending on the purpose. The ratio of the base unit; l is preferably 2 to 20 mol %, more preferably 5 to 15 mol %. The ratio of the base unit; m is preferably 15 to 40 mol %, more preferably 20 to 35 mol %. The ratio of the base unit; n is preferably 5 to 50 mol %, more preferably 10 to 45 mol %. The ratio of the base unit; r is preferably 10 to 35 mol %, more preferably 15 to 30 mol %.

In addition, the ratio [l/(m+r)] (mol/mol) of the base unit l to the total of the base units m and r is preferably 0.12 to 0.50, more preferably 0.15 to 0.40 and particularly preferably 0.18 to 0.35. The setting of the ratios of the base units; l, m, n and r in the above-mentioned ranges allows a molded product using the above-mentioned polymer to exhibit excellent properties such as to have transparency, heat resistance and inverse wavelength dispersion properties (in the case of having birefringence) together.

The weight-average molecular weight of the above-mentioned polymer is preferably 1,000 to 1,000,000, more preferably 3,000 to 500,000 and particularly preferably 5,000 to 300,000. The setting of the weight-average molecular weight in the above-mentioned range allows a molded product excellent in mechanical strength. The weight-average molecular weight can be calculated by the gel permeation chromatography (GPC) method through polystyrene as a standard sample. An analysis device to be used can be ‘HLC-8120GPC’ manufactured by TOSOH CORPORATION (column: TSK gel Super HM-H/H4000/H3000/H2000, column size: 6.0 mmI.D.×150 mm each, eluant: tetrahydrofuran, flow rate: 0.6 ml/min, detector: RI, column temperature: 40° C., injection volume: 20 μl).

The glass transition temperature of the above-mentioned polymer is preferably 90 to 190° C., more preferably 100 to 170° C. and particularly preferably 110 to 160° C. The setting of the glass transition temperature in the above-mentioned range allows a molded product excellent in heat resistance. The glass transition temperature can be measured by the DSC method.

### 2. Producing Method for Polymer

The above-mentioned polymer is produced by a method comprising at least a step of reacting a compound represented by the following general formula (IX) with polyvinyl alcohol resin in the presence of an acid catalyst while dissolved or dispersed in solvent. This reaction is condensation reaction with polyvinyl alcohol resin, and also called acetalization in the case of using aldehyde compounds or ketalization in the case of using ketone compounds.

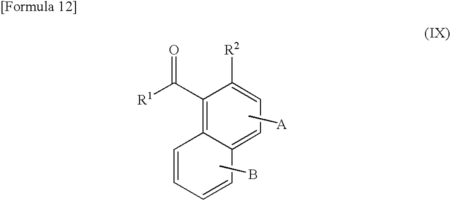

In the general formula (IX), R¹ denotes a hydrogen atom, a straight-chain or branched alkyl group with a carbon number of 1 to 4, or a substituted or unsubstituted phenyl group; R², A and B each independently denote a hydrogen atom, a halogen atom, a straight-chain or branched alkyl group with a carbon number of 1 to 4, a straight-chain or branched alkyl halide group with a carbon number of 1 to 4, a straight-chain or branched alkoxy group with a carbon number of 1 to 4, an alkoxycarbonyl group, an acyloxy group, an amino group, an azide group, a nitro group, a cyano group or a hydroxyl group (however, R² is not a hydrogen atom); and l denotes an integer of 2 or more.

In the above-mentioned general formula (IX), substituents R¹, R², A and B are properly selected in accordance with kinds of 1-naphthaldehydes or 1-naphthones reacted with polyvinyl alcohol resin. Examples of 1-naphthaldehydes or 1-naphthones are as described above.

The above-mentioned polyvinyl alcohol resin can properly adopt an appropriate resin depending on the purpose. The resin may be a straight-chain polymer or a branched polymer. Also, the resin may be a homopolymer or a copolymer polymerized from two kinds or more of monomers. In the case where the resin is a copolymer, the sequence of base units may be any of alternating, random and block. Typical examples of a copolymer include an ethylene-vinylalcohol copolymer.

The above-mentioned polyvinyl alcohol resin can be obtained, for example, in such a manner that a vinyl ester monomer is polymerized into a vinyl ester polymer, which is thereafter saponified to make a vinyl ester unit into a vinyl alcohol unit. Examples of the vinyl ester monomer include vinyl formate, vinyl acetate, vinyl propionate, vinyl valerate, vinyl laurate, vinyl stearate, vinyl benzoate, vinyl pivalate and vinyl ester of versatic acid. Among these vinyl ester monomers, vinyl acetate is particularly preferable.

The saponification degree of the above-mentioned polyvinyl alcohol resin is preferably 80 mol % or more, more preferably 90 mol % or more, particularly preferably 95 mol % or more and most preferably 98 mol % or more. The saponification degree can be measured in accordance with JIS K 6727 (1994). The setting of the saponification degree in the above-mentioned range allows a polymer excellent in durability.

Commercially available articles can be used directly for the above-mentioned polyvinyl alcohol resin. Alternatively, articles such that optional appropriate polymer denaturation is performed for commercial resin can be used. Examples of commercial polyvinyl alcohol resin include POVAL series manufactured by Kuraray Co., Ltd. (trade names “PVA-103, PVA-117, PVA-613, PVA-220, PVA-405 etc.”), EXCEVAL series manufactured by Kuraray Co., Ltd. (trade names “RS-4104, RS-3110, RS-1717 etc.”), EVAL series manufactured by Kuraray Co., Ltd. (trade names “L101, F101, H101, E105, G156 etc.”), GOHSENOL series manufactured by Nippon Synthetic Chemical Industry Co., Ltd. (trade names “NH-18, NH-300, A-300, C-500, GM-14 etc.”) and SOARNOL series manufactured by Nippon Synthetic Chemical Industry Co., Ltd. (trade names “D2908, DT2903, DC3203 etc.”).

The average degree of polymerization of the above-mentioned polyvinyl alcohol resin can be set at an optional appropriate value. The average degree of polymerization is preferably 400 to 5000, more preferably 800 to 3000 and particularly preferably 500 to 4000. The average degree of polymerization of the polyvinyl alcohol resin can be measured by a method in accordance with JIS K 6726 (1994).

With regard to the above-mentioned polyvinyl alcohol resin, viscosity (mPa·s) at a temperature of 20° C. in the case of 4% by weight-aqueous solution thereof is preferably 2 to 70, more preferably 10 to 50 and particularly preferably 20 to 40. The use of the resin with the viscosity allows a polymer excellent in strength and processability.

The production of the above-mentioned polymer preferably comprises the step of drying the polyvinyl alcohol resin before reaction (for example, condensation reaction). The drying temperature is preferably 30 to 150° C., more preferably 70 to 130° C. The drying time is preferably 10 minutes or more, more preferably 30 minutes or more. The adoption of the drying conditions allows a polymer with high degree of acetalization.

As the above-mentioned solvent, an appropriate solvent can be properly selected depending on the purpose. Examples of the solvent include alcohols such as methanol, ethanol, propanol and butanol, cyclic ethers such as 1,4-dioxane, and aprotic solvents such as N,N-dimethylformaldehyde, N-methylpyrrolidone and dimethyl sulfoxide. These solvents are used singly or by mixture of two kinds or more. The solvent may be used by mixture with water.

As the above-mentioned acid catalyst, an appropriate catalyst can be properly selected depending on the purpose. Examples of the acid catalyst include hydrochloric acid, sulfuric acid, phosphoric acid and para-toluenesulfonic acid. The acid catalyst is preferably para-toluenesulfonic acid.

The temperature for reacting the above-mentioned acid catalyst is typically higher than 0° C. and the boiling point or less of solvent to be used, preferably 10 to 100° C., and more preferably 20 to 80° C. The reaction time is preferably 30 minutes to 20 hours, more preferably 1 to 10 hours. The adoption of the reaction conditions allows a polymer having high degree of acetalization in high yield.

The degree of acetalization of the above-mentioned polymer is preferably 40 to 99 mol %, more preferably 50 to 95 mol % and particularly preferably 60 to 90 mol %. The setting of the degree of acetalization in the above-mentioned range allows a polymer further excellent in transparency, heat resistance and molding processability.

### 3. Application of Polymer

A polymer of the present invention is appropriately used for optical members by reason of being excellent in transparency and heat resistance. Examples of the above-mentioned optical members include such as birefringent film, plastic lens, prism, optical disc, optical fiber, photoresist, hologram, plastic substrate, light guide panel, diffuser panel, reflector plate and automobile parts.

The transmittance of the above-mentioned optical members in a wavelength of 550 nm is preferably 85% or more, more preferably 90% or more.

In the case where the above-mentioned optical members have birefringence, the in-plane birefringence (Δn[550]) of the optical members at a temperature of 23° C., which are measured by light with a wavelength of 550 nm, is 1×10⁻⁴ or more, preferably 0.001 to 0.01, more preferably 0.0015 to 0.008, particularly preferably 0.002 to 0.006 and most preferably 0.002 to 0.004. The above-mentioned polymer is excellent in molding processability, so that the above-mentioned Δn[550] can be adjusted in a wide range by drawing, for example.

The ratio (Δn[450]/Δn[550]) of Δn[450] to Δn[550] of the above-mentioned optical members is preferably smaller than 1, more preferably 0.50 to 0.97, particularly preferably 0.70 to 0.95 and most preferably 0.80 to 0.93. The setting of Δn[450]/Δn[550] in the above-mentioned range decreases difference of optical properties by wavelength in optical members utilizing light in a wide wavelength range.

The ratio (Δn[650]/Δn[550]) of Δn[650] to Δn[550] of the above-mentioned optical members is preferably larger than 1, more preferably 1.01 to 1.20, particularly preferably 1.02 to 1.15 and most preferably 1.03 to 1.10. The setting of Δn[650]/Δn[550] in the above-mentioned range decreases difference of optical properties by wavelength in optical members utilizing light in a wide wavelength range.

The absolute value (C[550] (m²/N)) of photoelastic coefficient of the above-mentioned optical members is preferably 1×10⁻¹² to 80×10⁻¹², more preferably 1×10⁻¹² to 50×10⁻¹² and particularly preferably 1×10⁻¹² to 30×10⁻¹². The use of optical members having the absolute value of photoelastic coefficient in the above-mentioned range allows a molded product which causes optical strain with difficulty, for example.

The coefficient of water absorption of the above-mentioned optical members is preferably 7% or less, more preferably 5% or less and particularly preferably 3% or less. The setting of coefficient of water absorption in the above-mentioned range allows optical members excellent in transparency even under an environment of high temperature and high humidity, for example.

### EXAMPLES

The present invention is further described by using the following examples. The present invention is not limited to only these examples. Each analysis method used in the examples is as follows.

### (1) Measurement of Composition Ratio:

The composition ratio was measured by using a nuclear magnetic resonance spectrometer [trade name “LA400”, manufactured by JEOL Ltd.] (solvent for measuring; heavy DMSO, frequency; 400 MHz, transmitter nucleus; ¹H, measured temperature; 70° C.).

### (2) Method of Measuring Glass Transition Temperature:

This was measured using a differential scanning calorimeter [trade name: “DSC-6200”, manufactured by Seiko Instruments Inc.] by a method according to JIS K 7121 (1987) (Method of measuring a transition temperature of plastics). Specifically, 3 mg of a powder sample was heated (heating speed: 10° C./min) in a nitrogen atmosphere (flow rate of gas: 80 ml/min) to raise the temperature of the sample, thereby measuring the temperature twice, to adopt the second data. The temperature of the calorimeter was calibrated using a standard material (indium).

### (3) Method of Measuring Thickness:

When the thickness was less than 10 μm, it was measured by spectrophotometer for a thin film [trade name: “Multi Channel Photo Detector MCPD-2000”, manufactured by Otsuka Electronics Co., Ltd.]. When the thickness was 10 μm or more, it was measured by using a digital micrometer (trade name: “KC-351C Model”, manufactured by Anritsu Corporation).

### (4) Measuring Method of Transmittance:

The transmittance was measured at light with a wavelength of 550 nm and a temperature of 23° C. by using an ultraviolet-visible spectrophotometer [trade name “V-560”, manufactured by JASCO Corporation].

### (5) Measuring Method of Absolute Value (C[550]) of Photoelastic Coefficient:

Both ends of a sample (a size of 2 cm×10 cm) were nipped while applying a stress (5 to 15 N) to measure a retardation value (23° C./wavelength of 550 nm) in the middle of the sample by using a spectroscopic ellipsometer [trade name “M-220”, manufactured by JASCO Corporation], and then the absolute value (C[550]) was calculated from the slope of a function of the stress and the retardation value.

### (6) Measuring Method of Birefringence (Δn):

The birefringence was calculated by converting retardation value at each wavelength and film thickness. The retardation value was measured in a room at a temperature of 23° C. by using a retardation meter on the principle of a parallel nicols rotation method [trade name “KOBRA21-ADH”, manufactured by OJI SCIENTIFIC INSTRUMENTS].

### (7) Measuring Method of Wavelength Dependence of Birefringence:

The wavelength dependence was measured in a room at a temperature of 23° C. by using a retardation meter on the principle of a parallel nicols rotation method [trade name “KOBRA21-ADH”, manufactured by OJI SCIENTIFIC INSTRUMENTS].

### Example 1

8.8 g of polyvinyl alcohol resin [trade name “NH-18”, manufactured by Nippon Synthetic Chemical Industry Co., Ltd. (polymerization degree=1800, saponification degree=99.0%)] was dried at a temperature of 105° C. for 2 hours and thereafter dissolved in 167.2 g of dimethyl sulfoxide (DMSO). 2.98 g of 2-methoxy-1-naphthaldehyde and 0.80 g of para-toluenesulfonic acid monohydrate were added thereto and stirred at a temperature of 40° C. for 1 hour. 23.64 g of 1,1-diethoxyethane (acetal) was further added to the reaction solution and stirred at a temperature of 40° C. for 4 hours. Thereafter, 2.13 g of triethylamine was added thereto to finish the reaction. The obtained crude product was subject to reprecipitation by 1 L-methanol. The filtered polymer was dissolved in tetrahydrofuran and subject to reprecipitation by methanol again. This was filtered and dried to obtain 12.7 g of a white polymer. When measured by ¹H-NMR, this polymer had a repeating unit represented by the following formula (X) and the ratio (molar ratio) of l:m:n was 12:60:28. The glass transition temperature of this polymer measured by a differential scanning calorimeter was 127° C.

¹H-NMR (DMSO): 0.8-2.3 (main chain methylene and methyl of an acetal portion), 3.4-4.4 (main chain methine to which an oxygen atom was bonded, methyl of a methoxy group and a hydroxyl group), 4.5-5.1 (methine of an acetal portion), 6.4 (methine of 2-methoxynaphthalene portion), 7.3-8.8 (aromatic proton of 2-methoxynaphthalene portion)

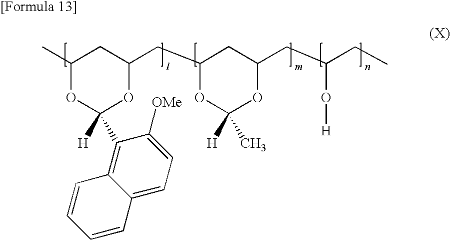

The above-mentioned polymer was dissolved in methyl ethyl ketone (MEK), applied on a polyethylene terephthalate film (a thickness of 70 μm) by an applicator, dried in an air-circulating drying oven and thereafter peeled off the above-mentioned polyethylene terephthalate film to produce a film with a thickness of 98 μm. This film was drawn by a drawing machine in the air-circulating drying oven at a temperature of 140° C. by 1.5 times to produce a drawn film A-1. The properties of the obtained drawn film A-1 are shown in Table 1.

TABLE 1

| | Example 1 | Example 2 | Example 3 | Example 4 | Example 5 | Example 6 | Example 7 |
|---|---|---|---|---|---|---|---|
| Drawn film | A-1 | A-2 | B-1 | C | D | E | B-2 |
| Thickness (μm) | 67 | 64 | 71 | 65 | 59 | 50 | 62 |
| Glass | 127 | 131 | 123 | 124 | 122 | 136 | 132 |
| transition | | | | | | | |
| temperature | | | | | | | |
| (° C.) | | | | | | | |
| Transmittance | 92 | 92 | 92 | 92 | 92 | 92 | 92 |
| (%) | | | | | | | |
| Δn[450] | 0.0028 | 0.0022 | 0.0027 | 0.0021 | 0.0024 | 0.0005 | 0.0025 |
| Δn[550] | 0.0030 | 0.0025 | 0.0031 | 0.0023 | 0.0026 | 0.0010 | 0.0029 |
| Δn[650] | 0.0031 | 0.0026 | 0.0033 | 0.0024 | 0.0027 | 0.0012 | 0.0031 |
| Δn[450]/Δn[550] | 0.93 | 0.88 | 0.87 | 0.91 | 0.92 | 0.50 | 0.87 |
| Δn[650]/Δn[550] | 1.03 | 1.04 | 1.06 | 1.04 | 1.04 | 1.20 | 1.05 |

### Example 2

12.42 g of a white polymer was obtained in the same manner as Example 1 except for modifying the used amount of 2-methoxy-1-naphthaldehyde into 3.72 g. When measured by ¹H-NMR, this polymer had a repeating unit represented by the following formula (X) and the ratio (molar ratio) of l:m:n was 13:50:37. The glass transition temperature of this polymer measured by a differential scanning calorimeter was 131° C.

The above-mentioned polymer was dissolved in methyl ethyl ketone (MEK), applied on a polyethylene terephthalate film (thickness is 70 μm) by an applicator, dried in an air-circulating drying oven and thereafter peeled off the polyethylene terephthalate film to produce a film with a thickness of 96 μm. This film was drawn by a drawing machine in the air-circulating drying oven at a temperature of 150° C. by 1.5 times to produce a drawn film A-2. The properties of the obtained drawn film A-2 are shown in Table 1.

### Example 3

8.8 g of polyvinyl alcohol resin [trade name “NH-18”, manufactured by Nippon Synthetic Chemical Industry Co., Ltd. (polymerization degree=1800, saponification degree=99.0%)] was dried at a temperature of 105° C. for 2 hours and thereafter dissolved in 167.2 g of dimethyl sulfoxide (DMSO). 2.98 g of 2-methoxy-1-naphthaldehyde and 0.80 g of para-toluenesulfonic acid monohydrate were added thereto and stirred at a temperature of 40° C. for 1 hour. 3.18 g of benzaldehyde was added to the reaction solution and stirred at a temperature of 40° C. for 1 hour, and thereafter 23.60 g 1,1-diethoxyethane (acetal) was further added thereto and stirred at a temperature of 40° C. for 3 hours. Thereafter, 2.13 g of triethylamine was added thereto to finish the reaction. The obtained crude product was subject to reprecipitation by 1 L-methanol. The filtered polymer was dissolved in tetrahydrofuran and subject to reprecipitation by methanol again. This was filtered and dried to obtain 11.5 g of a white polymer. When measured by ¹H-NMR, this polymer had a repeating unit represented by the following formula (XI) and the ratio (molar ratio) of l:m:n:o was 11:37:45:7. The glass transition temperature of this polymer measured by a differential scanning calorimeter was 123° C. The absolute value (C[550]) of photoelastic coefficient thereof was 2.4×10⁻¹¹ (m²/N).

¹H-NMR (DMSO): 0.8-2.3 (main chain methylene and methyl of an acetal portion), 3.4-4.4 (main chain methine to which an oxygen atom was bonded, methyl of a methoxy group and a hydroxyl group), 4.5-5.1 (methine of an acetal portion), 5.4-5.9 (methine of benzene portion), 6.4 (methine of 2-methoxynaphthalene portion), 7.1-7.5 (2-methoxynaphthalene and aromatic proton of benzene portion), 7.7-8.8 (aromatic proton of 2-methoxynaphthalene portion)

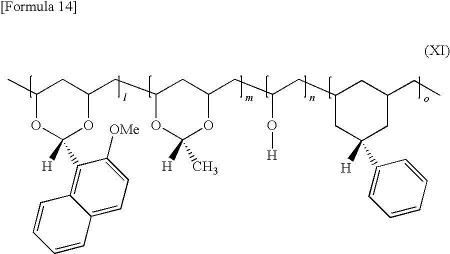

The above-mentioned polymer was dissolved in methyl ethyl ketone (MEK), applied on a polyethylene terephthalate film (a thickness of 70 μm) by an applicator, dried in an air-circulating drying oven and thereafter peeled off the above-mentioned polyethylene terephthalate film to produce a film with a thickness of 117 μm. This film was drawn by a drawing machine in the air-circulating drying oven at a temperature of 140° C. by 1.5 times to produce a drawn film B-1. The properties of the obtained drawn film B-1 are shown in Table 1.

### Example 4

14.3 g of a white polymer was obtained in the same manner as Example 3 except for adding 4.69 g of 2-naphthaldehyde instead of benzaldehyde. When measured by ¹H-NMR, this polymer had a repeating unit represented by the following formula (XII) and the ratio (molar ratio) of l:m:n:q was 10:30:52:8. The glass transition temperature of this polymer measured by a differential scanning calorimeter was 124° C.

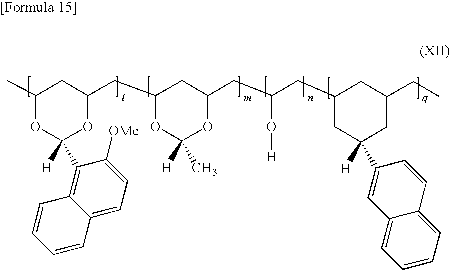

The above-mentioned polymer was dissolved in methyl ethyl ketone (MEK), applied on a polyethylene terephthalate film (a thickness of 70 μm) by an applicator, dried in an air-circulating drying oven and thereafter peeled off the above-mentioned polyethylene terephthalate film to produce a film with a thickness of 101 μm. This film was drawn by a drawing machine in the air-circulating drying oven at a temperature of 145° C. by 1.5 times to produce a drawn film C. The properties of the obtained drawn film C are shown in Table 1.

### Example 5

15.4 g of a white polymer was obtained in the same manner as Example 3 except for adding 3.56 g of cyclohexane carboxyaldehyde instead of benzaldehyde. When measured by ¹H-NMR, this polymer had a repeating unit represented by the following formula (XIII) and the ratio (molar ratio) of l:m:n:r was 13:27:36:23. The glass transition temperature of this polymer measured by a differential scanning calorimeter was 122° C.

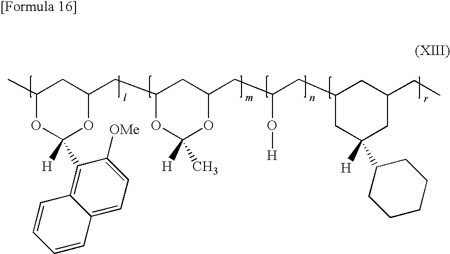

The above-mentioned polymer was dissolved in methyl ethyl ketone (MEK), applied on a polyethylene terephthalate film (a thickness of 70 μm) by an applicator, dried in an air-circulating drying oven and thereafter peeled off the above-mentioned polyethylene terephthalate film to produce a film with a thickness of 95 μm. This film was drawn by a drawing machine in the air-circulating drying oven at a temperature of 139° C. by 1.5 times to produce a drawn film D. The properties of the obtained drawn film D are shown in Table 1.

### Example 6

15.6 g of a white polymer was obtained in the same manner as Example 3 except for adding 4.87 g of para-tert-butylbenzaldehyde instead of benzaldehyde. When measured by ¹H-NMR, this polymer had a repeating unit represented by the following formula (XIV) and the ratio (molar ratio) of l:m:n:s was 9:29:53:8. The glass transition temperature of this polymer measured by a differential scanning calorimeter was 136° C.

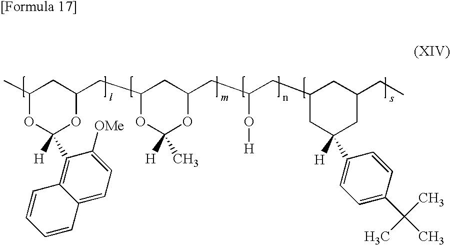

The above-mentioned polymer was dissolved in methyl ethyl ketone (MEK), applied on a polyethylene terephthalate film (a thickness of 70 μm) by an applicator, dried in an air-circulating drying oven and thereafter peeled off the above-mentioned polyethylene terephthalate film to produce a film with a thickness of 104 μm. This film was drawn by a drawing machine in the air-circulating drying oven at a temperature of 142° C. by 1.5 times to produce a drawn film E. The properties of the obtained drawn film E are shown in Table 1.

### Example 7

11.5 g of a white polymer was obtained in the same manner as Example 3 except for modifying the used amount of 2-methoxy-1-naphthaldehyde into 3.17 g. When measured by ¹H-NMR, this polymer had a repeating unit represented by the following formula (XI) and the ratio (molar ratio) of l:m:n:o was 13:38:41:8. The glass transition temperature of this polymer measured by a differential scanning calorimeter was 132° C.

The above-mentioned polymer was dissolved in methyl ethyl ketone (MEK), applied on a polyethylene terephthalate film (a thickness of 70 μm) by an applicator, dried in an air-circulating drying oven and thereafter peeled off the above-mentioned polyethylene terephthalate film to produce a film with a thickness of 106 μm. This film was drawn by a drawing machine in the air-circulating drying oven at a temperature of 138° C. by 1.5 times to produce a drawn film B-2. The properties of the obtained drawn film B-2 are shown in Table 1.

### Example 8

11.7 g of a white polymer was obtained in the same manner as Example 3 except for modifying the used amount of 2-methoxy-1-naphthaldehyde into 3.35 g. When measured by ¹H-NMR, this polymer had a repeating unit represented by the following formula (XI) and the ratio (molar ratio) of l:m:n:o was 13:40:39:8. The glass transition temperature of this polymer measured by a differential scanning calorimeter was 132° C.

The above-mentioned polymer was dissolved in methyl ethyl ketone (MEK), applied on a polyethylene terephthalate film (a thickness of 70 μm) by an applicator, dried in an air-circulating drying oven and thereafter peeled off the above-mentioned polyethylene terephthalate film to produce a film with a thickness of 110 μm. This film was drawn by a drawing machine in the air-circulating drying oven at a temperature of 138° C. by 1.5 times to produce a drawn film B-3. The properties of the obtained drawn film B-3 are shown in Table 2.

TABLE 2

| | Example | Example | Example | Example | Example | Example | Reference |
|---|---|---|---|---|---|---|---|
| | 8 | 9 | 10 | 11 | 12 | 13 | Example |
| Drawn film | B-3 | B-4 | B-5 | B-6 | B-7 | F | X |
| Thickness (μm) | 55 | 60 | 66 | 62 | 54 | 58 | 60 |
| Glass | 132 | 133 | 136 | 130 | 130 | 135 | 120 |
| transition | | | | | | | |
| temperature | | | | | | | |
| (° C.) | | | | | | | |
| Transmittance | 92 | 92 | 92 | 92 | 92 | 92 | 92 |
| (%) | | | | | | | |
| Δn[450] | 0.0025 | 0.0025 | 0.0025 | 0.0025 | 0.0025 | 0.0025 | 0.0015 |
| Δn[550] | 0.0029 | 0.0029 | 0.0029 | 0.0029 | 0.0029 | 0.0029 | 0.0016 |
| Δn[650] | 0.0031 | 0.0031 | 0.0031 | 0.0031 | 0.0031 | 0.0031 | 0.0016 |
| Δn[450]/Δn[550] | 0.87 | 0.87 | 0.87 | 0.87 | 0.87 | 0.87 | 0.94 |
| Δn[650]/Δn[550] | 1.05 | 1.05 | 1.05 | 1.05 | 1.05 | 1.05 | 1.00 |

### Example 9

11.7 g of a white polymer was obtained in the same manner as Example 3 except for modifying the used amount of 2-methoxy-1-naphthaldehyde into 3.53 g. When measured by ¹H-NMR, this polymer had a repeating unit represented by the following formula (XI) and the ratio (molar ratio) of l:m:n:o was 13:43:37:8. The glass transition temperature of this polymer measured by a differential scanning calorimeter was 133° C.

The above-mentioned polymer was dissolved in methyl ethyl ketone (MEK), applied on a polyethylene terephthalate film (a thickness of 70 μm) by an applicator, dried in an air-circulating drying oven and thereafter peeled off the above-mentioned polyethylene terephthalate film to produce a film with a thickness of 103 μm. This film was drawn by a drawing machine in the air-circulating drying oven at a temperature of 139° C. by 1.5 times to produce a drawn film B-4. The properties of the obtained drawn film B-4 are shown in Table 2.

### Example 10

11.8 g of a white polymer was obtained in the same manner as Example 3 except for modifying the used amount of 2-methoxy-1-naphthaldehyde into 3.71 g. When measured by ¹H-NMR, this polymer had a repeating unit represented by the following formula (XI) and the ratio (molar ratio) of l:m:n:o was 14:39:39:8. The glass transition temperature of this polymer measured by a differential scanning calorimeter was 136° C.

The above-mentioned polymer was dissolved in methyl ethyl ketone (MEK), applied on a polyethylene terephthalate film (a thickness of 70 μm) by an applicator, dried in an air-circulating drying oven and thereafter peeled off the above-mentioned polyethylene terephthalate film to produce a film with a thickness of 104 μm. This film was drawn by a drawing machine in the air-circulating drying oven at a temperature of 139° C. by 1.5 times to produce a drawn film B-5. The properties of the obtained drawn film B-5 are shown in Table 2.

### Example 11

11.9 g of a white polymer was obtained in the same manner as Example 3 except for adding 4.57 g of dimethylacetal instead of 1,1-diethoxyethane. When measured by ¹H-NMR, this polymer had a repeating unit represented by the following formula (XI) and the ratio (molar ratio) of l:m:n:o was 10:25:52:11. The glass transition temperature of this polymer measured by a differential scanning calorimeter was 130° C.

The above-mentioned polymer was dissolved in methyl ethyl ketone (MEK), applied on a polyethylene terephthalate film (a thickness of 70 μm) by an applicator, dried in an air-circulating drying oven and thereafter peeled off the above-mentioned polyethylene terephthalate film to produce a film with a thickness of 96 μm. This film was drawn by a drawing machine in the air-circulating drying oven at a temperature of 139° C. by 1.5 times to produce a drawn film B-6. The properties of the obtained drawn film B-6 are shown in Table 2.

### Example 12

11.5 g of a white polymer was obtained in the same manner as Example 3 except for adding 8.81 g of acetaldehyde instead of 1,1-diethoxyethane. When measured by ¹H-NMR, this polymer had a repeating unit represented by the following formula (XI) and the ratio (molar ratio) of l:m:n:o was 12:53:28:7. The glass transition temperature of this polymer measured by a differential scanning calorimeter was 130° C.

The above-mentioned polymer was dissolved in methyl ethyl ketone (MEK), applied on a polyethylene terephthalate film (a thickness of 70 μm) by an applicator, dried in an air-circulating drying oven and thereafter peeled off the above-mentioned polyethylene terephthalate film to produce a film with a thickness of 95 μm. This film was drawn by a drawing machine in the air-circulating drying oven at a temperature of 139° C. by 1.5 times to produce a drawn film B-7. The properties of the obtained drawn film B-7 are shown in Table 2.

### Example 13

8.8 g of polyvinyl alcohol resin [trade name “NH-18”, manufactured by Nippon Synthetic Chemical Industry Co., Ltd. (polymerization degree=1800, saponification degree=99.0%)] was dried at a temperature of 105° C. for 2 hours and thereafter dissolved in 167.2 g of dimethyl sulfoxide (DMSO). 2.98 g of 2-methoxy-1-naphthaldehyde and 0.80 g of para-toluenesulfonic acid monohydrate were added thereto and stirred at a temperature of 40° C. for 1 hour. 3.18 g of benzaldehyde was added to the reaction solution and stirred at a temperature of 40° C. for 1 hour, and thereafter 10.4 g of 2,2-dimethoxypropane was further added thereto and stirred at a temperature of 40° C. for 3 hours. Thereafter, 2.13 g of triethylamine was added thereto to finish the reaction. The obtained crude product was subject to reprecipitation by 1 L-methanol. The filtered polymer was dissolved in tetrahydrofuran and subject to reprecipitation by methanol again. This was filtered and dried to obtain 18.8 g of a white polymer. When measured by ¹H-NMR, this polymer had a repeating unit represented by the following formula (XV) and the ratio (molar ratio) of l:m:n:o was 13:31:43:13. The glass transition temperature of this polymer measured by a differential scanning calorimeter was 135° C.

¹H-NMR (DMSO): 0.8-2.3 (main chain methylene and methyl of an acetal portion), 3.4-4.4 (main chain methine to which an oxygen atom was bonded, methyl of a methoxy group and a hydroxyl group), 5.4-5.9 (methine of benzene portion), 6.4 (methine of 2-methoxynaphthalene portion), 7.1-7.5 (2-methoxynaphthalene and aromatic proton of benzene portion), 7.7-8.8 (aromatic proton of 2-methoxynaphthalene portion)

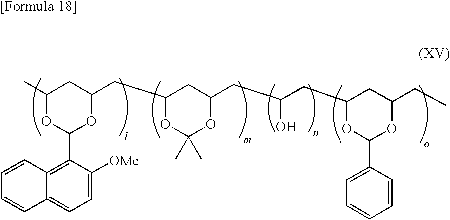

The above-mentioned polymer was dissolved in methyl ethyl ketone (MEK), applied on a polyethylene terephthalate film (a thickness of 70 μm) by an applicator, dried in an air-circulating drying oven and thereafter peeled off the above-mentioned polyethylene terephthalate film to produce a film with a thickness of 94 μm. This film was drawn by a drawing machine in the air-circulating drying oven at a temperature of 139° C. by 1.5 times to produce a drawn film F. The properties of the obtained drawn film F are shown in Table 2.

### Reference Example

11.3 g of a white polymer was obtained in the same manner as Example 1 except for using 3.18 g of benzaldehyde instead of 2-methoxy-1-naphthaldehyde. When measured by ¹H-NMR, this polymer had a repeating unit represented by the following formula (XX) and the ratio (molar ratio) of l:m:n was 24:63:13. The glass transition temperature of this polymer measured by a differential scanning calorimeter was 120° C.

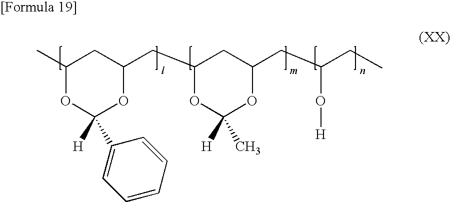

The above-mentioned polymer was dissolved in methyl ethyl ketone (MEK), applied on a glass substrate by an applicator, dried in an air-circulating drying oven and thereafter peeled off the above-mentioned glass substrate to produce a film with a thickness of 101 μm. This film was drawn by a drawing machine in the air-circulating drying oven at a temperature of 140° C. by 1.5 times to produce a drawn film X. The properties of the obtained drawn film X are shown in Table 2.

### [Evaluations]

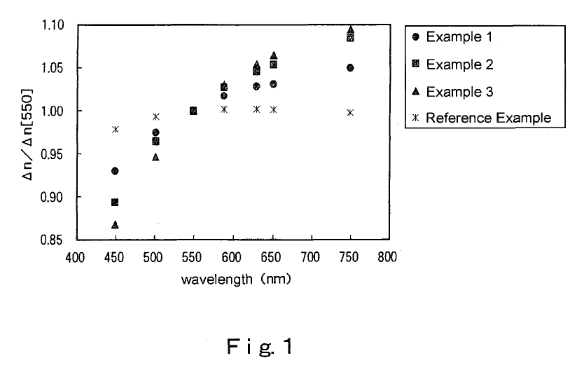

FIG. 1 is a graph showing wavelength dependence of birefringence in a visible light region with regard to a drawn film of examples. As shown in FIG. 1, the drawn films obtained in Examples 1 to 3 exhibited properties (inverse wavelength dispersion properties), such that higher birefringence was offered in measuring by light with longer wavelength. Similarly, the drawn films obtained in Examples 4 to 13 exhibited inverse wavelength dispersion properties. The drawn film obtained in Reference Example exhibited no inverse wavelength dispersion properties for the reason that the birefringence was approximately constant regardless of measuring wavelength.

### INDUSTRIAL APPLICABILITY

As described above, a polymer of the present invention is extremely useful for optical applications by reason of being excellent in transparency and heat resistance.

1. A polymer having at least a repeating unit represented by the following general formula (I): 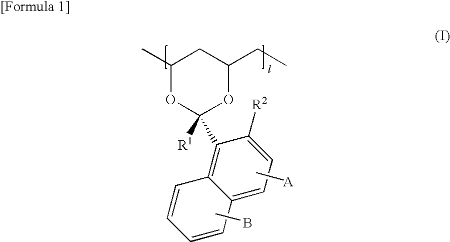
wherein in the general formula (I), R¹ denotes a hydrogen atom, a straight-chain or branched alkyl group with a carbon number of 1 to 4, or a substituted or unsubstituted phenyl group; R², A and B each independently denote a hydrogen atom, a halogen atom, a straight-chain or branched alkyl group with a carbon number of 1 to 4, a straight-chain or branched alkyl halide group with a carbon number of 1 to 4, a straight-chain or branched alkoxy group with a carbon number of 1 to 4, an alkoxycarbonyl group, an acyloxy group, an amino group, an azide group, a nitro group, a cyano group or a hydroxyl group (however, R² is not a hydrogen atom); and l denotes an integer of 2 or more.

2. The polymer according to claim 1, wherein the R¹ is a hydrogen atom.

3. The polymer according to claim 1, wherein the R² is a methoxy group.

4. The polymer according to claim 1, further having a repeating unit represented by the following general formula (II): 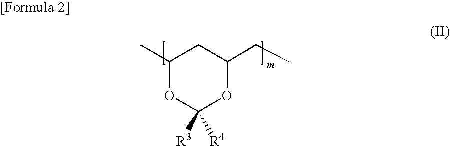
wherein in the general formula (II), R³ and R⁴ each independently denote a hydrogen atom, a straight-chain or branched alkyl group with a carbon number of 1 to 4, a substituted or unsubstituted cycloalkyl group with a carbon number of 5 to 10, a substituted or unsubstituted phenyl group, a substituted or unsubstituted naphthyl group, or a substituted or unsubstituted heterocyclic group; and m denotes an integer of 2 or more.

5. The polymer according to claim 4, wherein the R³ is a hydrogen atom.

6. The polymer according to claim 4, wherein the R⁴ is a straight-chain or branched alkyl group with a carbon number of 1 to 4, or a substituted or unsubstituted phenyl group.

7. The polymer according to claim 1, further having a repeating unit represented by the following general formula (III): 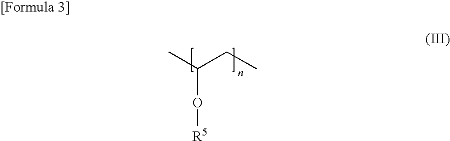
wherein in the general formula (III), R⁵ denotes a hydrogen atom, a straight-chain or branched alkyl group with a carbon number of 1 to 4, a benzyl group, a silyl group, a phosphate group, an acyl group, a benzoyl group, or a sulfonyl group; and n denotes an integer of 2 or more.

8. The polymer according to claim 1, wherein a glass transition temperature thereof is 90 to 190° C.

9. An optical member containing the polymer according to claim 1.

10. A producing method for the polymer comprising at least a step of reacting a compound represented by the following general formula (IX) with polyvinyl alcohol resin in the presence of an acid catalyst while dissolved or dispersed in solvent: 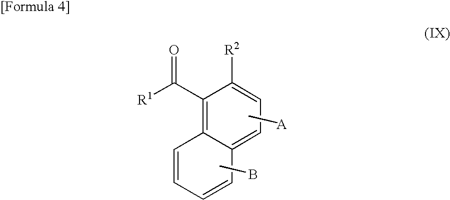
wherein in the general formula (IX), R¹ denotes a hydrogen atom, a straight-chain or branched alkyl group with a carbon number of 1 to 4, or a substituted or unsubstituted phenyl group; and R², A and B each independently denote a hydrogen atom, a halogen atom, a straight-chain or branched alkyl group with a carbon number of 1 to 4, a straight-chain or branched alkyl halide group with a carbon number of 1 to 4, a straight-chain or branched alkoxy group with a carbon number of 1 to 4, an alkoxycarbonyl group, an acyloxy group, an amino group, an azide group, a nitro group, a cyano group or a hydroxyl group (however, R² is not a hydrogen atom).

11. The producing method for the polymer according to claim 10, wherein saponification degree of the polyvinyl alcohol resin is 80 mol % or more.

12. The producing method for the polymer according to claim 10, wherein average degree of polymerization of the polyvinyl alcohol resin is 400 to 5000.

13. The producing method for the polymer according to claim 10, comprising a step of drying the polyvinyl alcohol resin before the reaction.

14. The producing method for the polymer according to claim 10, wherein the solvent is N,N-dimethylformaldehyde, N-methylpyrrolidone or dimethyl sulfoxide.

15. The producing method for the polymer according to claim 10, wherein the acid catalyst is hydrochloric acid, sulfuric acid, phosphoric acid or para-toluenesulfonic acid.
